(19) United States
(12) Patent Application Publication
(10) Pub. No.: US 2023/0064575 A1
(43) Pub. Date: Mar. 2, 2023

(54) CONTROL METHOD, PROJECTION APPARATUS, AND CONTROL PROGRAM

(71) Applicant: FUJIFILM Corporation, Tokyo (JP)

(72) Inventors: Kazuki INOUE, Saitama-shi (JP); Tomonori MASUDA, Saitama-shi (JP); Akihiro ISHIZUKA, Saitama-shi (JP); Kazuki ISHIDA, Saitama-shi (JP)

(73) Assignee: FUJIFILM Corporation, Tokyo (JP)

(21) Appl. No.: 18/047,074

(22) Filed: Oct. 17, 2022

Related U.S. Application Data
(63) Continuation of application No. PCT/JP2021/008306, filed on Mar. 3, 2021.

(30) Foreign Application Priority Data
Apr. 24, 2020 (JP) 2020-077533

(51) Int. Cl. H04N 9/31; G09G 3/00

(52) U.S. Cl. CPC H04N 9/3185; H04N 9/3188; G09G 3/002; G09G 2354/00; G09G 2340/04

(57) ABSTRACT

A control method of a projection system that includes a projection portion and a processor and projects a content image to a first range set in a projection range of the projection portion, includes: by the processor, projecting a first image for providing an instruction for the first range by a user to a position corresponding to an operation of the user from the projection portion such that the first image is superimposed on a projection image; and executing a control of setting the first range in accordance with an operation of the user performed on the first image.

### CROSS REFERENCE TO RELATED APPLICATION

This is a continuation of International Application No. PCT/JP2021/008306 filed on Mar. 3, 2021, and claims priority from Japanese Patent Application No. 2020-077533 filed on Apr. 24, 2020, the entire disclosures of which are incorporated herein by reference.

### BACKGROUND OF THE INVENTION

### 1. Field of the Invention

The present invention relates to a control method, a projection apparatus, and a computer readable medium storing a control program.

### 2. Description of the Related Art

JP2014-103518A discloses a projection apparatus configured to receive a user designation of a range of an image region including an image in a projection range using a corner marker or the like and match the image region to a cylindrical target region for geometric correction related to projection to a cylindrical surface.

JP2014-187520A discloses an image processing apparatus configured to, in a case of projecting an image over two surfaces intersecting with each other at an angle, individually perform distortion correction on each of two parts obtained by dividing the projected image using a straight line.

### SUMMARY OF THE INVENTION

One embodiment according to the disclosed technology provides a control method, a projection apparatus, and a computer readable medium storing a control program that facilitate setting of a range in which a content image is projected.

A projection method of an embodiment according to the disclosed technology is a control method of a projection system that includes a projection portion and a processor and projects a content image to a first range set in a projection range of the projection portion, the control method comprising, by the processor, projecting a first image for providing an instruction for the first range by a user to a position corresponding to a user operation from the projection portion such that the first image is superimposed on a projection image, and executing a control of setting the first range in accordance with a user operation performed on the first image.

A projection apparatus of another embodiment according to the disclosed technology is a projection apparatus comprising a projection portion, and a processor, in which the projection apparatus projects a content image to a first range set in a projection range of the projection portion, and the processor is configured to project a first image for providing an instruction for the first range by a user to a position corresponding to a user operation from the projection portion such that the first image is superimposed on a projection image, and execute a control of setting the first range in accordance with a user operation performed on the first image.

A control program stored in a computer readable medium of still another embodiment according to the disclosed technology is a control program of a projection apparatus that includes a projection portion and a processor and projects a content image to a first range set in a projection range of the projection portion, the control program causing the processor to execute a process comprising projecting a first image for providing an instruction for the first range by a user to a position corresponding to a user operation from the projection portion such that the first image is superimposed on a projection image, and setting the first range in accordance with a user operation performed on the first image.

Another projection method of still another embodiment according to the disclosed technology is a control method of a projection system that includes a projection portion and a processor and projects a content image to a first range set in a projection range of the projection portion, the control method comprising, by the processor, projecting a first image for providing an instruction for the first range by a user to a position except for an end part from the projection portion such that the first image is superimposed on a projection image, and executing a control of setting the first range in accordance with a user operation performed on the first image.

Another projection apparatus of still another embodiment according to the disclosed technology is a projection apparatus comprising a projection portion, and a processor, in which the projection apparatus projects a content image to a first range set in a projection range of the projection portion, and the processor is configured to project a first image for providing an instruction for the first range by a user to a position except for an end part from the projection portion such that the first image is superimposed on a projection image, and execute a control of setting the first range in accordance with a user operation performed on the first image.

Another control program stored in a computer readable medium of still another embodiment according to the disclosed technology is a control program of a projection apparatus that includes a projection portion and a processor and projects a content image to a first range set in a projection range of the projection portion, the control program causing the processor to execute a process comprising projecting a first image for providing an instruction for the first range by a user to a position except for an end part from the projection portion such that the first image is superimposed on a projection image, and setting the first range in accordance with a user operation performed on the first image.

According to the present invention, a control method, a projection apparatus, and a computer readable medium storing a control program that can facilitate setting of a range in which a content image is projected can be provided.

### BRIEF DESCRIPTION OF THE DRAWINGS

FIG. 1 is a schematic diagram illustrating a schematic configuration of a projection apparatus 10 of Embodiment 1.

FIG. 2 is a schematic diagram illustrating an example of an internal configuration of a projection portion 1 illustrated in FIG. 1.

FIG. 3 is a schematic diagram illustrating an exterior configuration of the projection apparatus 10.

FIG. 4 is a schematic cross-sectional view of an optical unit 106 of the projection apparatus 10 illustrated in FIG. 3.

FIG. 5 is a diagram (Part 1) illustrating a projection procedure of a content image by the projection apparatus 10.

FIG. 6 is a diagram (Part 2) illustrating the projection procedure of the content image by the projection apparatus 10.

FIG. 7 is a diagram (Part 3) illustrating the projection procedure of the content image by the projection apparatus 10.

FIG. 8 is a diagram (Part 4) illustrating the projection procedure of the content image by the projection apparatus 10.

FIG. 9 is a diagram (Part 5) illustrating the projection procedure of the content image by the projection apparatus 10.

FIG. 10 is a diagram (Part 6) illustrating the projection procedure of the content image by the projection apparatus 10.

FIG. 11 is a diagram (Part 7) illustrating the projection procedure of the content image by the projection apparatus 10.

FIG. 12 is a flowchart illustrating an example of projection processing of the content image by a control device 4.

FIG. 13 is a diagram illustrating a modification example of the projection of the content image by the projection apparatus 10.

FIG. 14 is a diagram (Part 1) illustrating an example of range setting for Modification Example 1 of a projection object 6 by the projection apparatus 10.

FIG. 15 is a diagram (Part 2) illustrating an example of the range setting for Modification Example 1 of the projection object 6 by the projection apparatus 10.

FIG. 16 is a diagram (Part 1) illustrating an example of range setting for Modification Example 2 of the projection object 6 by the projection apparatus 10.

FIG. 17 is a diagram (Part 2) illustrating an example of the range setting for Modification Example 2 of the projection object 6 by the projection apparatus 10.

FIG. 18 is a diagram illustrating another example of the range setting for Modification Example 2 of the projection object 6 by the projection apparatus 10.

FIG. 19 is a diagram (Part 1) illustrating an example of range setting for projection objects 6a and 6b by the projection apparatus 10.

FIG. 20 is a diagram (Part 2) illustrating an example of the range setting for the projection objects 6a and 6b by the projection apparatus 10.

FIG. 21 is a diagram (Part 1) illustrating a modification example of a first image for providing an instruction for a content projection range by a user.

FIG. 22 is a diagram (Part 2) illustrating a modification example of the first image for providing the instruction for the content projection range by the user.

FIG. 23 is a flowchart illustrating an example of projection processing of the content image by the control device 4 of Embodiment 2.

### DESCRIPTION OF THE PREFERRED EMBODIMENTS

Hereinafter, an example of embodiments of the present invention will be described with reference to the drawings.

### Embodiment 1

<Schematic Configuration of Projection Apparatus 10 of Embodiment 1>

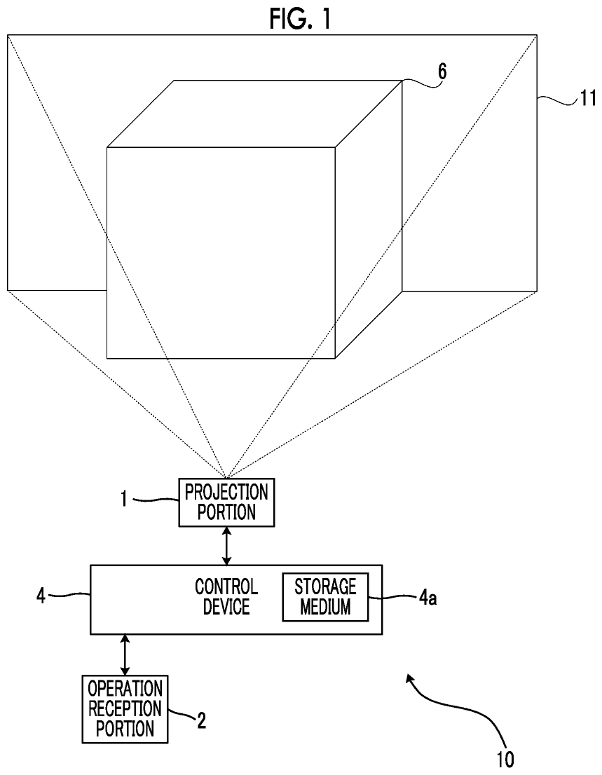

FIG. 1 is a schematic diagram illustrating a schematic configuration of a projection apparatus 10 of Embodiment 1.

The projection apparatus 10 comprises a projection portion 1, a control device 4, and an operation reception portion 2. The projection portion 1 is configured with, for example, a liquid crystal projector or a projector using liquid crystal on silicon (LCOS). Hereinafter, the projection portion 1 will be described as a liquid crystal projector.

The control device 4 is a device including a control portion configured with various processors, a communication interface (not illustrated) for communicating with each portion, and a storage medium 4a such as a hard disk, a solid state drive (SSD), or a read only memory (ROM) and generally controls the projection portion 1.

Examples of the various processors of the control portion of the control device 4 include a central processing unit (CPU) that is a general-purpose processor performing various processing by executing a program, a programmable logic device (PLD) such as a field programmable gate array (FPGA) that is a processor having a circuit configuration changeable after manufacturing, or a dedicated electric circuit such as an application specific integrated circuit (ASIC) that is a processor having a circuit configuration dedicatedly designed to execute specific processing.

More specifically, a structure of these various processors is an electric circuit in which circuit elements such as semiconductor elements are combined. The control portion of the control device 4 may be configured with one of the various processors or may be configured with a combination of two or more processors of the same type or different types (for example, a combination of a plurality of FPGAs or a combination of a CPU and an FPGA).

The operation reception portion 2 detects an instruction (user instruction) from a user by receiving various operations from the user. The operation reception portion 2 may be a button, a key, a joystick, or the like provided in the control device 4 or a reception portion or the like that receives a signal from a remote controller for remotely operating the control device 4.

A projection object 6 is an object having a projection surface on which a projection image is displayed by the projection portion 1. In the example illustrated in FIG. 1, the projection object 6 is a rectangular parallelepiped of which only one surface faces the projection apparatus 10 side. This one surface is the projection surface. It is assumed that upper, lower, left, and right sides of the projection object 6 in FIG. 1 are upper, lower, left, and right sides of the actual projection object 6. In addition, in the example in FIG. 1, there is a flat wall behind (in a depth direction in FIG. 1) the projection object 6.

The projection range 11 is a range irradiated with projection light by the projection portion 1. In the example illustrated in FIG. 1, the projection range 11 is rectangular. In addition, in the example illustrated in FIG. 1, a projection range 11 is a range that includes the projection surface of the projection object 6 and is larger than the projection surface of the projection object 6.

In the example illustrated in FIG. 1, a case of setting a content projection range in which the projection apparatus 10 projects a content image in the projection range 11 by a user operation will be described. The content projection range is an example of a first range according to an embodiment of the present invention. For example, it is assumed that the user wants to set the content projection range in which the projection apparatus 10 projects the content image, to the entire projection surface of the projection object 6. In this case, which range in the projection range 11 is the content projection range projected to the projection surface of the projection apparatus 10 needs to be set in the projection apparatus 10.

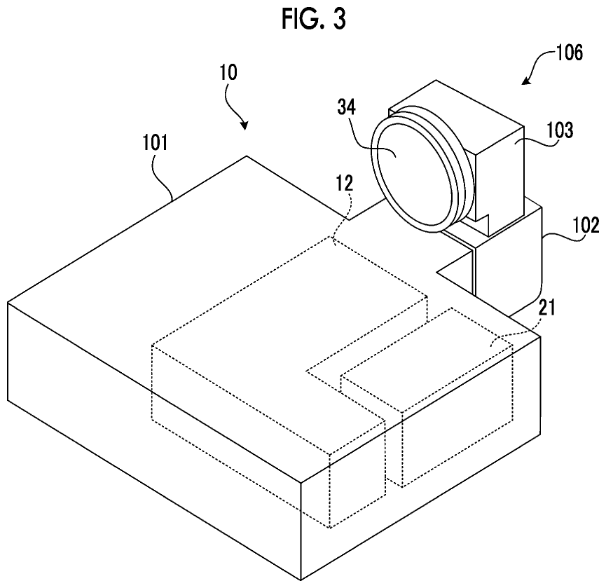

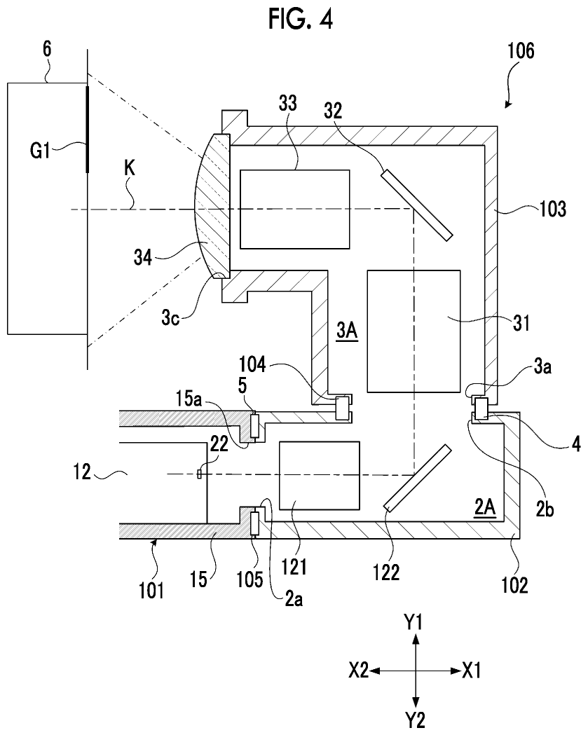

The projection portion 1, the control device 4, and the operation reception portion 2 are implemented by, for example, one device (for example, refer to FIG. 3 and FIG. 4). Alternatively, the projection portion 1, the control device 4, and the operation reception portion 2 may be separate devices that cooperate by communicating with each other.

<Internal Configuration of Projection Portion 1 Illustrated in FIG. 1>

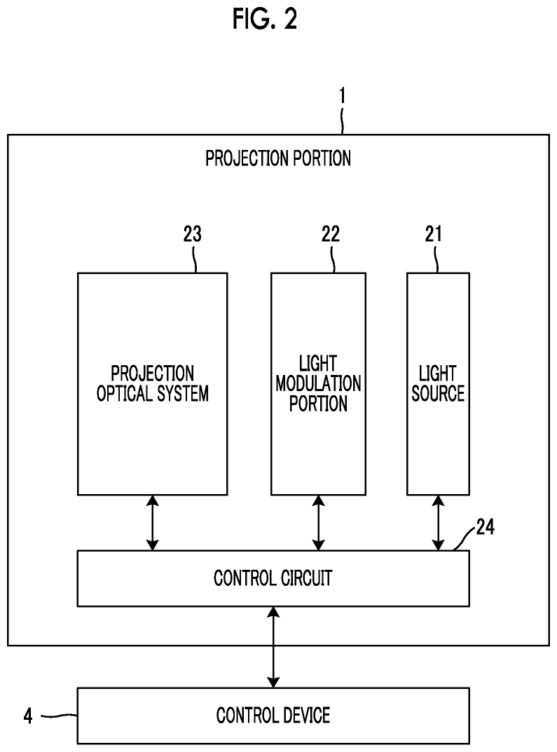

FIG. 2 is a schematic diagram illustrating an example of an internal configuration of the projection portion 1 illustrated in FIG. 1.

As illustrated in FIG. 2, the projection portion 1 comprises a light source 21, a light modulation portion 22, a projection optical system 23, and a control circuit 24.

The light source 21 includes a light emitting element such as a laser or a light emitting diode (LED) and emits, for example, white light.

The light modulation portion 22 is configured with three liquid crystal panels that emit each color image by modulating, based on image information, each color light which is emitted from the light source 21 and is separated into three colors of red, blue, and green by a color separation mechanism, not illustrated. Filters of red, blue, and green may be mounted in each of the three liquid crystal panels, and each color image may be emitted by modulating the white light emitted from the light source 21 in each liquid crystal panel.

The light from the light source 21 and the light modulation portion 22 is incident on the projection optical system 23. The projection optical system 23 includes at least one lens and is composed of, for example, a relay optical system. The light that has passed through the projection optical system 23 is projected to the projection object 6.

The control circuit 24 projects an image based on display data to the projection object 6 by controlling the light source 21, the light modulation portion 22, and the projection optical system 23 based on the display data input from the control device 4. The display data input into the control circuit 24 is configured with three constituents of red display data, blue display data, and green display data.

In addition, the control circuit 24 enlarges or reduces the projection range 11 (refer to FIG. 1) of the projection portion 1 by changing the projection optical system 23 based on an instruction input from the control device 4. In addition, the control device 4 may move the projection range 11 of the projection portion 1 by changing the projection optical system 23 based on the operation received by the operation reception portion 2 from the user.

In addition, the projection apparatus 10 comprises a shift mechanism that mechanically or optically moves the projection range 11 while maintaining an image circle of the projection optical system 23. The image circle of the projection optical system 23 is a region in which the projection light incident on the projection optical system 23 appropriately passes through the projection optical system 23 in terms of a light fall-off, color separation, edge part curvature, or the like.

The shift mechanism is implemented by at least any of an optical system shift mechanism that performs optical system shifting, or an electronic shift mechanism that performs electronic shifting.

The optical system shift mechanism is, for example, a mechanism (for example, refer to FIG. 3 and FIG. 4) that moves the projection optical system 23 in a direction perpendicular to an optical axis, or a mechanism that moves the light modulation portion 22 in the direction perpendicular to the optical axis instead of moving the projection optical system 23. In addition, the optical system shift mechanism may perform the movement of the projection optical system 23 and the movement of the light modulation portion 22 in combination.

The electronic shift mechanism is a mechanism that performs pseudo shifting of the projection range 11 by changing a range through which the light is transmitted in the light modulation portion 22.

In addition, the projection apparatus 10 may comprise a projection direction changing mechanism that moves the image circle of the projection optical system 23 and the projection range 11. The projection direction changing mechanism is a mechanism that changes a projection direction of the projection portion 1 by changing a direction of the projection portion 1 by mechanical rotation (for example, refer to FIG. 3 and FIG. 4).

<Mechanical Configuration of Projection Apparatus 10>

FIG. 3 is a schematic diagram illustrating an exterior configuration of the projection apparatus 10. FIG. 4 is a schematic cross-sectional view of an optical unit 106 of the projection apparatus 10 illustrated in FIG. 3. FIG. 4 illustrates a cross section in a plane along an optical path of the light emitted from a body part 101 illustrated in FIG. 3.

As illustrated in FIG. 3, the projection apparatus 10 comprises the body part 101 and the optical unit 106 that is provided to protrude from the body part 101. In the configuration illustrated in FIG. 3, the operation reception portion 2, the control device 4, and the light source 21, the light modulation portion 22, and the control circuit 24 in the projection portion 1 are provided in the body part 101. The projection optical system 23 in the projection portion 1 is provided in the optical unit 106.

The optical unit 106 comprises a first member 102 supported by the body part 101 and a second member 103 supported by the first member 102.

The first member 102 and the second member 103 may be an integrated member. The optical unit 106 may be configured to be attachable to and detachable from the body part 101 (in other words, interchangeably configured).

The body part 101 includes a housing 15 (refer to FIG. 4) in which an opening 15a (refer to FIG. 4) for passing light is formed in a part connected to the optical unit 106.

As illustrated in FIG. 3, the light source 21 and a light modulation unit 12 including the light modulation portion 22 (refer to FIG. 2) that generates an image by spatially modulating the light emitted from the light source 21 based on input image data are provided inside the housing 15 of the body part 101.

The light emitted from the light source 21 is incident on the light modulation portion 22 of the light modulation unit 12 and is spatially modulated and emitted by the light modulation portion 22.

As illustrated in FIG. 4, the image formed by the light spatially modulated by the light modulation unit 12 is incident on the optical unit 106 through the opening 15a of the housing 15 and is projected to the projection object 6 as a projection target object. Accordingly, an image G1 is visible from an observer.

As illustrated in FIG. 4, the optical unit 106 comprises the first member 102 including a hollow portion 2A connected to the inside of the body part 101, the second member 103 including a hollow portion 3A connected to the hollow portion 2A, a first optical system 121 and a reflective member 122 arranged in the hollow portion 2A, a second optical system 31, a reflective member 32, a third optical system 33, and a lens 34 arranged in the hollow portion 3A, a shift mechanism 105, and a projection direction changing mechanism 104.

The first member 102 is a member having, for example, a rectangular cross-sectional exterior, in which an opening 2a and an opening 2b are formed in surfaces perpendicular to each other. The first member 102 is supported by the body part 101 in a state where the opening 2a is arranged at a position facing the opening 15a of the body part 101. The light emitted from the light modulation portion 22 of the light modulation unit 12 of the body part 101 is incident into the hollow portion 2A of the first member 102 through the opening 15a and the opening 2a.

An incidence direction of the light incident into the hollow portion 2A from the body part 101 will be referred to as a direction X1. A direction opposite to the direction X1 will be referred to as a direction X2. The direction X1 and the direction X2 will be collectively referred to as a direction X. In addition, in FIG. 4, a direction from the front to the back of the page and an opposite direction will be referred to as a direction Z. In the direction Z, the direction from the front to the back of the page will be referred to as a direction Z1, and the direction from the back to the front of the page will be referred to as a direction Z2.

In addition, a direction perpendicular to the direction X and the direction Z will be referred to as a direction Y. In the direction Y, an upward direction in FIG. 4 will be referred to as a direction Y1, and a downward direction in FIG. 4 will be referred to as a direction Y2. In the example in FIG. 4, the projection apparatus 10 is arranged such that the direction Y2 is a vertical direction.

The projection optical system 23 illustrated in FIG. 2 is composed of the first optical system 121, the reflective member 122, the second optical system 31, the reflective member 32, the third optical system 33, and the lens 34. An optical axis K of the projection optical system 23 is illustrated in FIG. 4. The first optical system 121, the reflective member 122, the second optical system 31, the reflective member 32, the third optical system 33, and the lens 34 are arranged in this order from the light modulation portion 22 side along the optical axis K.

The first optical system 121 includes at least one lens and guides the light that is incident on the first member 102 from the body part 101 and travels in the direction X1, to the reflective member 122.

The reflective member 122 reflects the light incident from the first optical system 121 in the direction Y1. The reflective member 122 is configured with, for example, a mirror. In the first member 102, the opening 2b is formed on the optical path of the light reflected by the reflective member 122, and the reflected light travels to the hollow portion 3A of the second member 103 by passing through the opening 2b.

The second member 103 is a member having an approximately T-shaped cross-sectional exterior, in which an opening 3a is formed at a position facing the opening 2b of the first member 102. The light that has passed through the opening 2b of the first member 102 from the body part 101 is incident into the hollow portion 3A of the second member 103 through the opening 3a. The first member 102 and the second member 103 may have any cross-sectional exterior and are not limited to the above.

The second optical system 31 includes at least one lens and guides the light incident from the first member 102 to the reflective member 32.

The reflective member 32 guides the light incident from the second optical system 31 to the third optical system 33 by reflecting the light in the direction X2. The reflective member 32 is configured with, for example, a mirror.

The third optical system 33 includes at least one lens and guides the light reflected by the reflective member 32 to the lens 34.

The lens 34 is arranged in an end part of the second member 103 on the direction X2 side in the form of closing the opening 3c formed in this end part. The lens 34 projects the light incident from the third optical system 33 to the projection object 6.

The projection direction changing mechanism 104 is a rotation mechanism that rotatably connects the second member 103 to the first member 102. By the projection direction changing mechanism 104, the second member 103 is configured to be rotatable about a rotation axis (specifically, the optical axis K) that extends in the direction Y. The projection direction changing mechanism 104 is not limited to an arrangement position illustrated in FIG. 4 as long as the projection direction changing mechanism 104 can rotate the optical system. In addition, the number of rotation mechanisms is not limited to one, and a plurality of rotation mechanisms may be provided.

The shift mechanism 105 is a mechanism for moving the optical axis K of the projection optical system (in other words, the optical unit 106) in a direction (direction Y in FIG. 4) perpendicular to the optical axis K. Specifically, the shift mechanism 105 is configured to be capable of changing a position of the first member 102 in the direction Y with respect to the body part 101. The shift mechanism 105 may manually move the first member 102 or electrically move the first member 102.

FIG. 4 illustrates a state where the first member 102 is moved as far as possible to the direction Y1 side by the shift mechanism 105. By moving the first member 102 in the direction Y2 by the shift mechanism 105 from the state illustrated in FIG. 4, a relative position between a center of the image (in other words, a center of a display surface) formed by the light modulation portion 22 and the optical axis K changes, and the image G1 projected to the projection object 6 can be shifted (translated) in the direction Y2.

The shift mechanism 105 may be a mechanism that moves the light modulation portion 22 in the direction Y instead of moving the optical unit 106 in the direction Y. Even in this case, the image G1 projected to the projection object 6 can be moved in the direction Y2.

<Projection Procedure of Content Image by Projection Apparatus 10>

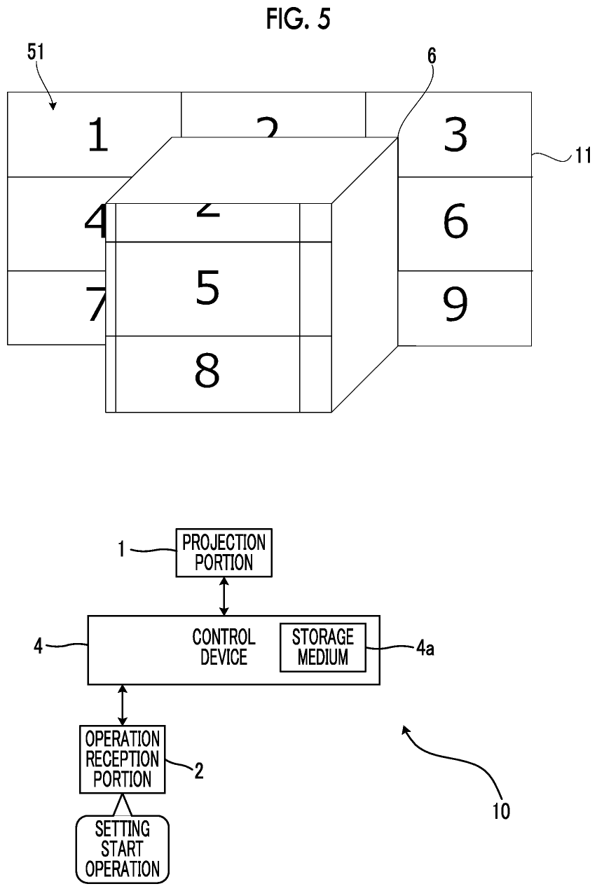

FIG. 5 to FIG. 11 are diagrams illustrating a projection procedure of the content image by the projection apparatus 10. Here, as in the example in FIG. 1, it is assumed that the projection range 11 of the projection apparatus 10 is adjusted to include the projection surface of the projection object 6 by adjusting a position of the projection apparatus 10 or adjusting an angle of view of the projection optical system 23 of the projection apparatus 10.

As illustrated in FIG. 5, first, in a case where a setting start operation of providing an instruction to start setting the content projection range is received from the operation reception portion 2, the projection apparatus 10 projects a number image 51 to the projection range 11. The number image 51 is an example of a second image divided into a plurality of ranges.

In the example in FIG. 5, the number image 51 is divided into nine ranges in a 3×3 matrix. In addition, in the number image 51, each range of the plurality of divided ranges includes an identifier for selecting the range by the user. In the example in FIG. 5, the number image 51 is an image in which numbers “1” to “9” are included in nine ranges, respectively.

In the number image 51, any arrangement of the numbers “1” to “9” is possible. In addition, the number of divisions of the number image 51 is not limited to nine and can be any number greater than or equal to two. In addition, a divided shape of the number image 51 is not limited to a matrix and may be other divided shapes. In addition, the identifier is not limited to a number such as “1” to “9” and can be various identifiers not overlapping with each other, such as alphabets “A” to “I”.

In addition, in the example in FIG. 5, the projection object 6 is positioned near a center of the projection range 11. Consequently, a state where the entire range of “5” at a center of the number image 51 and a part of each range other than “5” are projected to the projection surface of the projection object 6 is set.

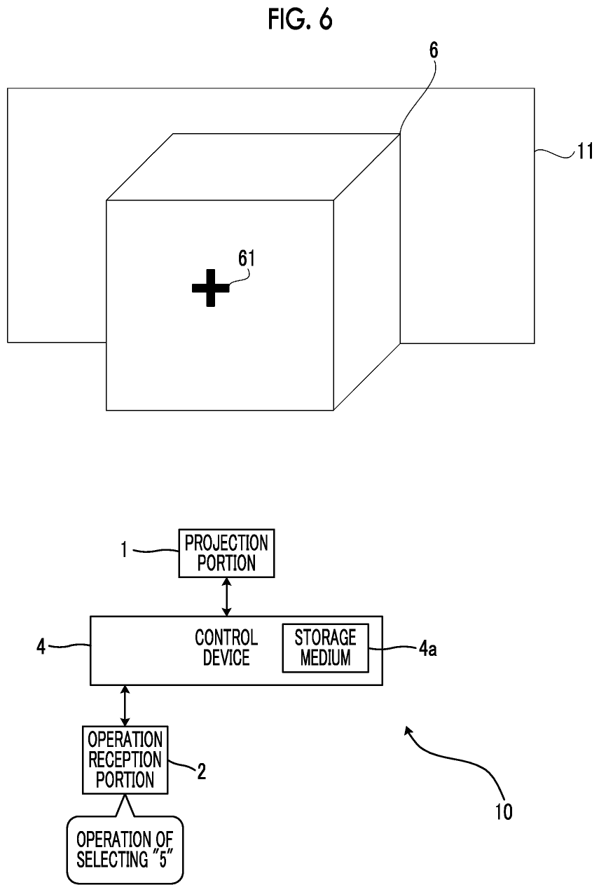

Next, as illustrated in FIG. 6, the user who adjusts the projection apparatus 10 sees the number image 51 and performs an operation of selecting “5” from “1” to “9” on the operation reception portion 2 since the range of “5” is near a center of the projection surface of the projection object 6. Regarding this point, the projection apparatus 10 projects a cursor 61 to a predetermined position (for example, a center) within the range of “5” in the number image 51.

In the example in FIG. 6, the projection apparatus 10 does not project the number image 51 illustrated in FIG. 5 in projecting the cursor 61. However, the cursor 61 may be projected while the number image 51 remains projected, or the cursor 61 may be projected by not projecting only a part (for example, the number “5”) of the number image 51.

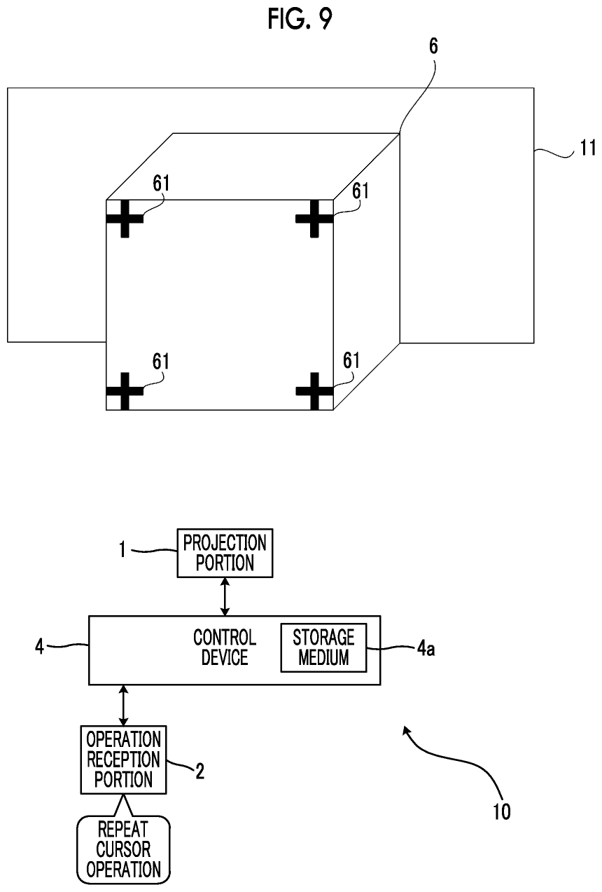

The cursor 61 is an image that moves in the projection image in accordance with a user operation. For example, the projection of the cursor 61 can be performed by including the cursor 61 in the projection image projected to the projection range 11. Accordingly, the cursor 61 can be projected to be superimposed on the projection image. In the example illustrated in FIG. 9, while the cursor 61 is a cross-shaped cursor, a shape of the cursor 61 is not limited thereto and, for example, can be various shapes such as a quadrangle and a circle.

The projection apparatus 10 projects the projection image including the cursor 61 to a position in a range selected by a user operation in the number image 51. Accordingly, difficulty in finding the cursor 61 by the user because of the cursor 61 projected to a position except for the projection object 6 can be avoided.

Particularly, in a case where the wall behind the projection object 6 is separated from the projection object 6 or an object such as a wall is not present behind the projection object 6, it is difficult that the cursor 61 is visible by the user in a case where the cursor 61 is projected to a position except for the projection object 6. Regarding this point, according to the projection apparatus 10, since the cursor 61 is projected to the projection object 6 by causing the user to perform an operation of selecting a number projected to the projection object 6 among the numbers of the number image 51, projection of the cursor 61 to a position except for the projection object 6 can be avoided.

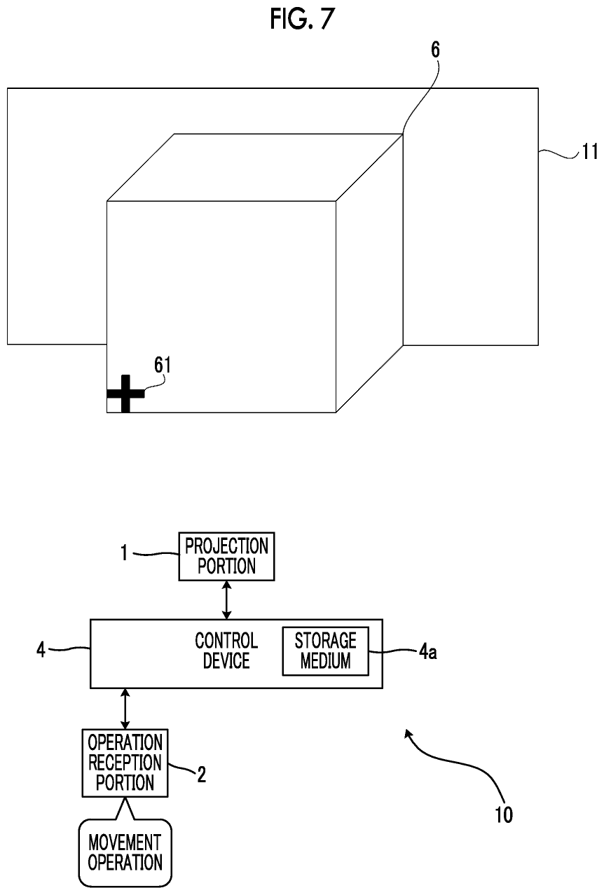

Next, as illustrated in FIG. 7, the user performs a movement operation of moving the cursor 61 on the operation reception portion 2. In the example in FIG. 7, the user performs the movement operation such that the cursor 61 moves to the lower left of the projection surface of the projection object 6. Regarding this point, the projection apparatus 10 moves the cursor 61 in a direction and an amount corresponding to the received movement operation. For example, the movement of the cursor 61 can be performed by changing a position including the cursor 61 in the projection image projected to the projection range 11.

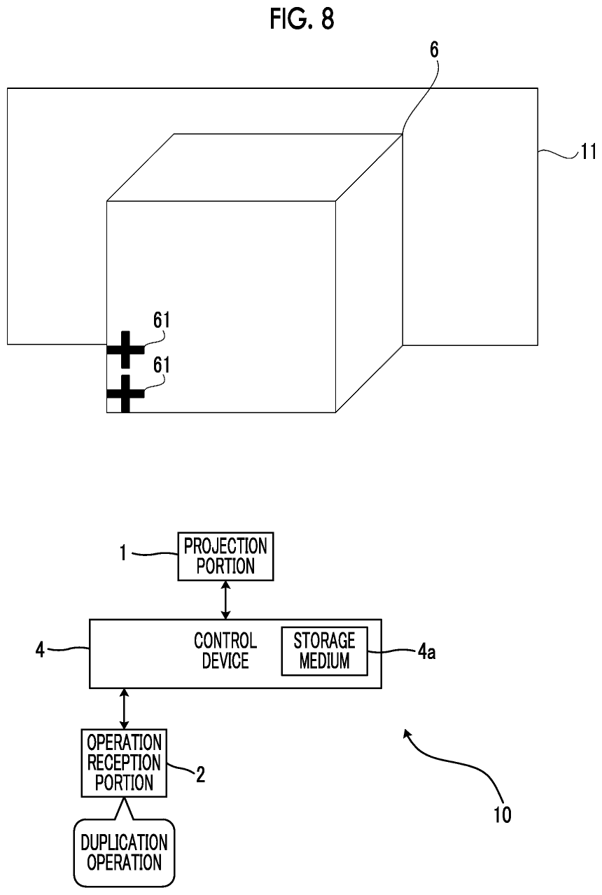

Next, as illustrated in FIG. 8, the user performs a duplication operation of duplicating the cursor 61 on the operation reception portion 2. Regarding this point, the projection apparatus 10 duplicates the cursor 61. For example, the duplication of the cursor 61 can be performed by adding the cursor 61 included in the projection image projected to the projection range 11.

In a state where a plurality of the cursors 61 are projected, processing corresponding to the movement operation and the duplication operation are performed for the cursor 61 selected as a selection cursor among the plurality of cursors 61. The user can switch the selection cursor among the plurality of cursors 61 by performing a selection cursor switching operation of providing an instruction to switch the selection cursor among the plurality of cursors 61 on the operation reception portion 2.

Next, as illustrated in FIG. 9, the user arranges the cursor 61 at four corners of the projection surface of the projection object 6 by repeating a cursor operation including the movement operation, the duplication operation, and the selection cursor switching operation.

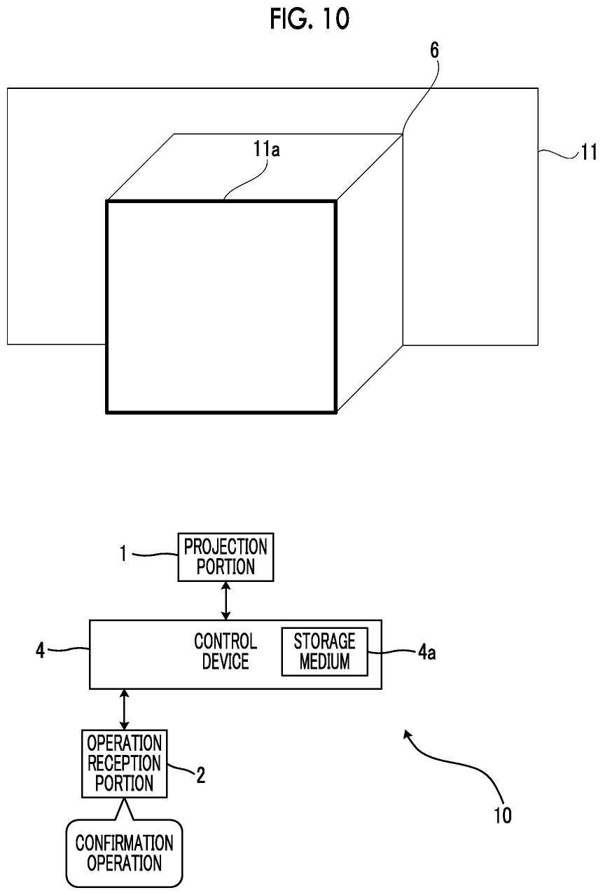

Next, as illustrated in FIG. 10, the user performs a confirmation operation of providing an instruction to confirm a range specified by the current cursor 61 as the content projection range on the operation reception portion 2. Regarding this point, the projection apparatus 10 sets a rectangular range of which four corners are positions at which four cursors 61 are arranged in FIG. 9, as a content projection range 11a. In FIG. 10, the content projection range 11a is virtually illustrated by a thick line.

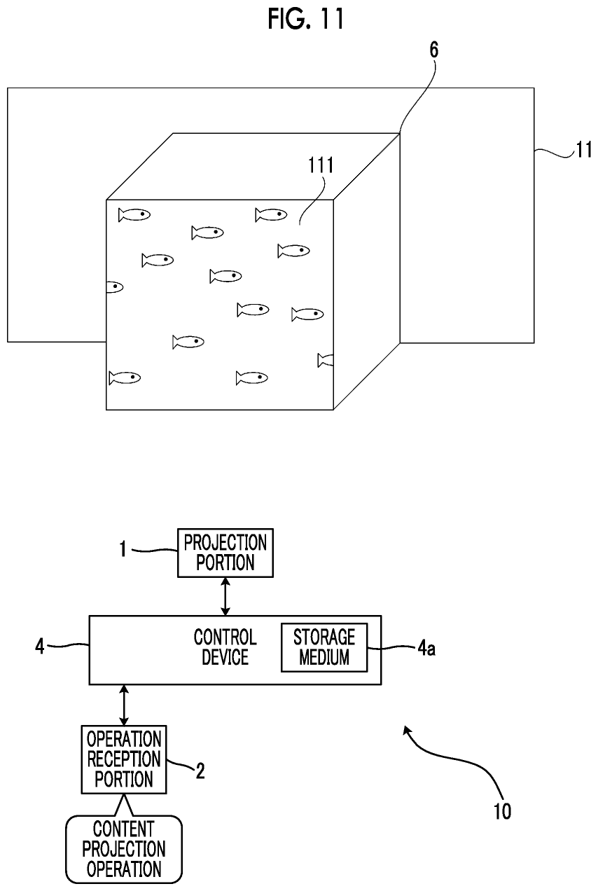

Next, as illustrated in FIG. 11, the user performs a content projection operation of providing an instruction to start projecting the content image to the content projection range 11a on the operation reception portion 2. Regarding this point, the projection apparatus 10 generates a content image 111 corresponding to the set content projection range 11a and starts projecting the generated content image 111 to the content projection range 11a.

In the example illustrated in FIG. 11, the content image 111 is a motion picture image showing a state where a large number of fishes are swimming. However, the content image 111 is not limited thereto and can be any still picture image or motion picture image.

<Projection Processing of Content Image by Control Device 4>

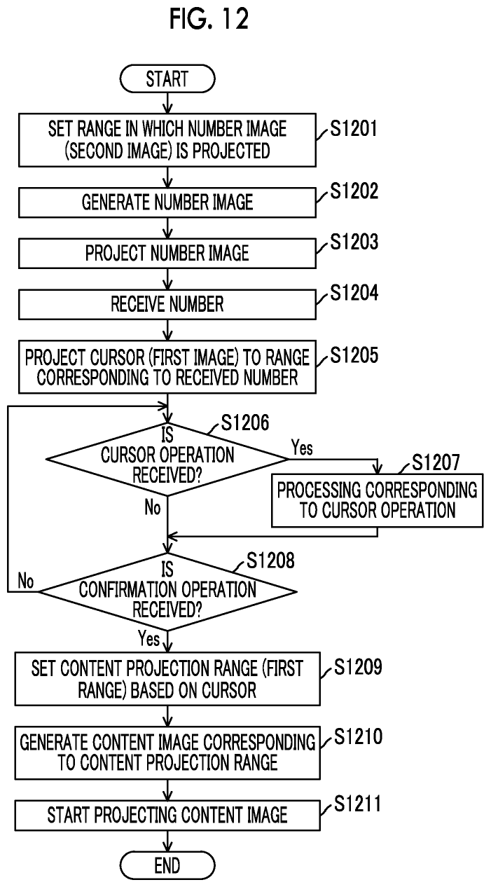

FIG. 12 is a flowchart illustrating an example of projection processing of the content image by the control device 4. For example, the control device 4 executes the projection processing illustrated in FIG. 12. For example, the control device 4 is triggered to start the projection processing illustrated in FIG. 12 by the setting start operation. Here, it is assumed that the projection range 11 of the projection apparatus 10 is adjusted to include the projection surface of the projection object 6 as in the examples in FIG. 5 to FIG. 10.

First, the control device 4 sets a range in which the number image 51 (second image) is projected in the projection range 11 (step S1201). For example, the control device 4 sets the entire range of the projection range 11 of the projection portion 1 as a range in which the number image 51 is projected.

Alternatively, the control device 4 may set a range of a part of the projection range 11 as the range in which the number image 51 is projected, in accordance with a user operation or the like. For example, the control device 4 may receive a designation of a range of a part such as an upper half, a lower half, a right half, or a left half of the projection range 11 from the operation reception portion 2 and set the received range as the range in which the number image 51 is projected.

By projecting the number image 51 to a range selected by a user operation in the projection range 11, it is possible to project the number image 51 by limiting the range and efficiently set an initial display position of the cursor 61 in a case where the user perceives an approximate position of the projection surface of the projection object 6 in the projection range 11.

Next, the control device 4 generates the number image 51 (step S1202). That is, the control device 4 sets a shape of the number image 51, the number of divided ranges of the number image 51, the identifier attached to each range of the number image 51, and the like. For example, information about the number image 51 is stored in advance in a memory of the control device 4. The control device 4 generates the number image 51 by reading out the information.

Alternatively, the control device 4 may generate the number image 51 that is divided in accordance with a user operation. For example, the control device 4 generates the number image 51 by receiving a setting of the largest number of the number image 51 or the number of divided ranges in the number image 51 from the operation reception portion 2. Accordingly, the number image 51 divided in accordance with a user operation can be flexibly generated with respect to the projection surface of the projection object 6 having various sizes and shapes.

Alternatively, the control device 4 may generate the number image 51 that is divided based on a size of the projection range 11. For example, the control device 4 generates the number image 51 that is divided into more ranges as the projection range 11 is increased. Accordingly, for example, in a case where the projection range 11 is large, the number image 51 divided into a large number of ranges can be projected. Thus, difficulty in designating the range in which the cursor 61 is projected because each range of the number image 51 is excessively large can be avoided.

Alternatively, the control device 4 may generate the number image 51 that is divided based on a shape of the projection range 11. For example, in a case where the projection range 11 is a vertically long rectangle, the control device 4 generates the number image 51 of which the number of divisions in a vertical direction is larger than the number of divisions in a horizontal direction (that is, the number of dividing lines in the horizontal direction is larger than the number of dividing lines in the vertical direction). In addition, in a case where the projection range 11 is a horizontally long rectangle, the control device 4 generates the number image 51 of which the number of divisions in the horizontal direction is larger than the number of divisions in the vertical direction. Accordingly, for example, in a case where the projection range 11 is a vertically long rectangle, the number image 51 divided into a large number of ranges in the vertical direction can be projected. Thus, difficulty in designating the range in which the cursor 61 is projected because each range of the number image 51 is excessively large in the vertical direction can be avoided.

Next, the control device 4 controls the projection portion 1 to project the number image 51 generated in step S1202 to the range decided in step S1201 (step S1203). Next, the control device 4 receives a number selected by the user among the numbers included in the number image 51 projected in step S1203 from the operation reception portion 2 (step S1204). Next, the control device 4 controls the projection portion 1 to project the cursor 61 (first image) to a range corresponding to the number received in step S1204 among the ranges of the number image 51 (step S1205).

Next, the control device 4 determines whether or not the cursor operation such as the movement operation, the duplication operation, or the selection cursor switching operation is received from the operation reception portion 2 (step S1206). In a case where the cursor operation is received (step S1206: Yes), the control device 4 performs processing of the cursor 61 corresponding to the received cursor operation (step S1207) and transitions to step S1208.

In step S1206, in a case where the cursor operation is not received (step S1206: No), the control device 4 determines whether or not the confirmation operation is received from the operation reception portion 2 (step S1208). In a case where the confirmation operation is not received (step S1208: No), the control device 4 returns to step S1206.

In step S1208, in a case where the confirmation operation is received (step S1208: Yes), the control device 4 sets the content projection range (first range) based on the cursor 61 at a time of the confirmation operation (step S1209).

Next, the control device 4 generates the content image corresponding to the content projection range set in step S1209 (step S1210). For example, the control device 4 generates the content image corresponding to the content projection range by performing processing such as enlargement, reduction, or trimming on the original content image.

Next, the control device 4 controls the projection portion 1 to start projecting the content image generated in step S1210 to the content projection range set in step S1209 (step S1211) and finishes the series of processing.

While processing up to the projection of the content image is described using FIG. 12, the control device 4 may project the content image after receiving the content projection operation from the operation reception portion 2.

In addition, for example, after projecting the cursor 61 in step S1205, the control device 4 may receive an operation of providing an instruction to receive a number again from the operation reception portion 2 and return to step S1203 in a case where this operation is received. In addition, for example, after starting the projection of the content image 111 using the reflective member 122, the control device 4 may receive an operation of providing an instruction to set the content projection range 11a again from the operation reception portion 2 and return to step S1203 or step S1206 in a case where this operation is received.

<Modification Example of Projection of Content Image by Projection Apparatus 10>

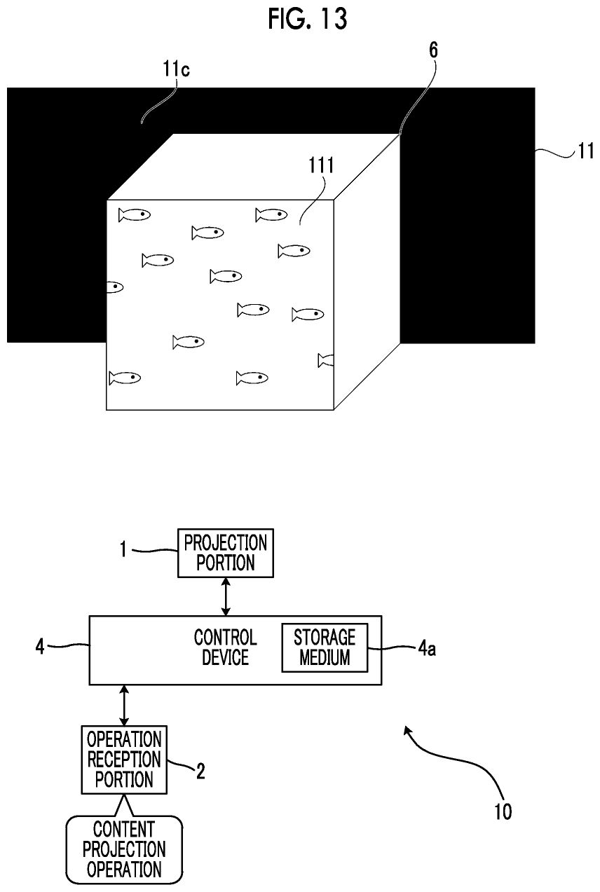

FIG. 13 is a diagram illustrating a modification example of the projection of the content image by the projection apparatus 10.

As illustrated in FIG. 13, the projection apparatus 10 may project a uniformly black image to an edge part range 11c other than the content projection range 11a in the projection range 11. For example, the control device 4 sets a color of a part corresponding to the edge part range 11c in the projection image projected to the projection range 11 to black. Accordingly, light is not projected to the edge part range 11c from the projection portion 1, and the edge part range 11c is uniformly black. Thus, even in a case where an object such as a wall is present behind the projection object 6, an observer can easily recognize the range of the content image 111.

The projection apparatus 10 may project an image different from the content image 111 to the edge part range 11c instead of causing light to be not transmitted through the edge part range 11c. For example, the projection apparatus 10 may set an image of a uniform color (as an example, grey) or an image of a constant pattern (for example, a fine lattice pattern) in the part corresponding to the edge part range 11c in the projection image projected to the projection range 11. Accordingly, an image different from the content image 111 is projected to the edge part range 11c. Thus, even in a case where an object such as a wall is present behind the projection object 6, an observer can easily recognize the range of the content image 111.

<Range Setting for Modification Example 1 of Projection Object 6 by Projection Apparatus 10>

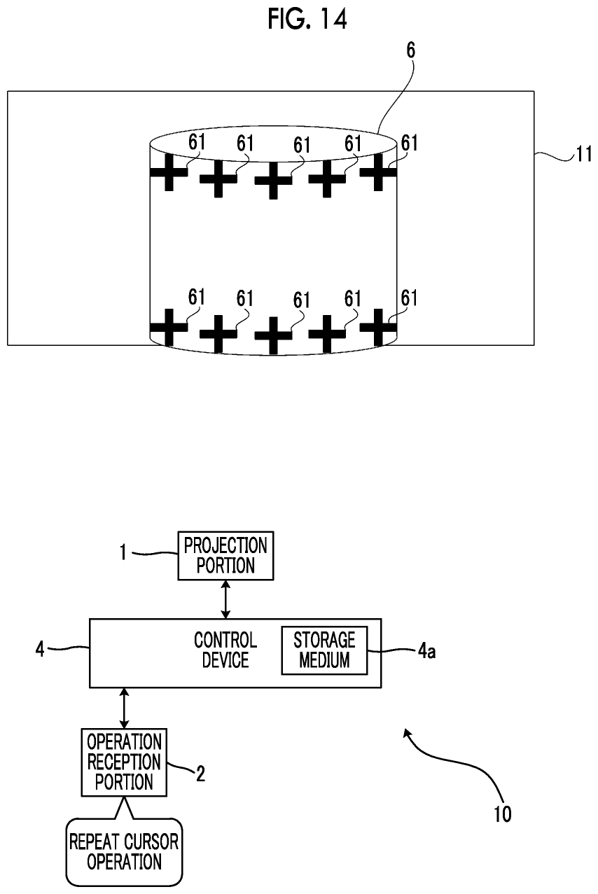

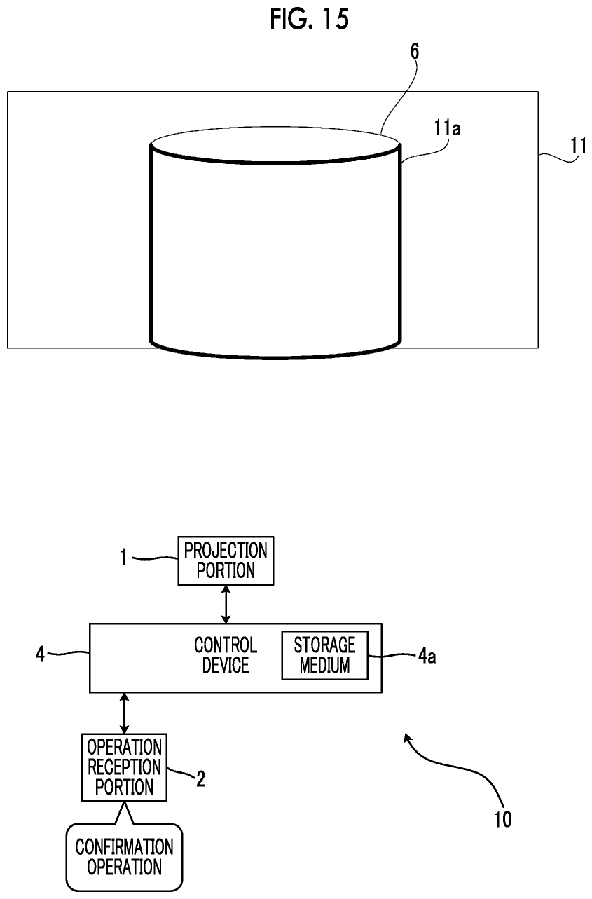

FIG. 14 and FIG. 15 are diagrams illustrating an example of range setting for Modification Example 1 of the projection object 6 by the projection apparatus 10.

While a case where the projection object 6 is a rectangular parallelepiped is described, a shape of the projection object 6 is not limited thereto. For example, the projection object 6 may be a cylindrical object as illustrated in FIG. 14. Here, a case of using a side surface (curved surface) of the projection object 6 seen from the projection apparatus 10 side as the projection surface will be described. For example, for the projection apparatus 10, the user sets a shape of the side surface (for example, a side surface of a cylinder) in the projection apparatus 10.

Even in this case, the projection apparatus 10 first projects the cursor 61 based on a result of the reception of the designation of the number from the user by projecting the number image 51. The user arranges the cursor 61 to surround a desired projection surface in the projection object 6 by performing various cursor operations described above on the operation reception portion 2. In the example illustrated in FIG. 14, the entire range of the projection object 6 seen from the projection apparatus 10 side is surrounded using 10 cursors 61.

In this state, as illustrated in FIG. 15, in a case where the user performs the confirmation operation, the projection apparatus 10 sets the range surrounded by the cursors 61 as the content projection range 11a. For example, the projection apparatus 10 sets the content projection range 11a that is a curved surface using linear interpolation based on positions of each of the plurality of cursors 61.

The projection apparatus 10 generates the content image 111 in accordance with the content projection range 11a and projects the generated content image 111 to the content projection range 11a. In generating the content image 111, the projection apparatus 10 may perform distortion correction corresponding to the curved surface of the content projection range 11a in accordance with a user operation.

<Range Setting for Modification Example 2 of Projection Object 6 by Projection Apparatus 10>

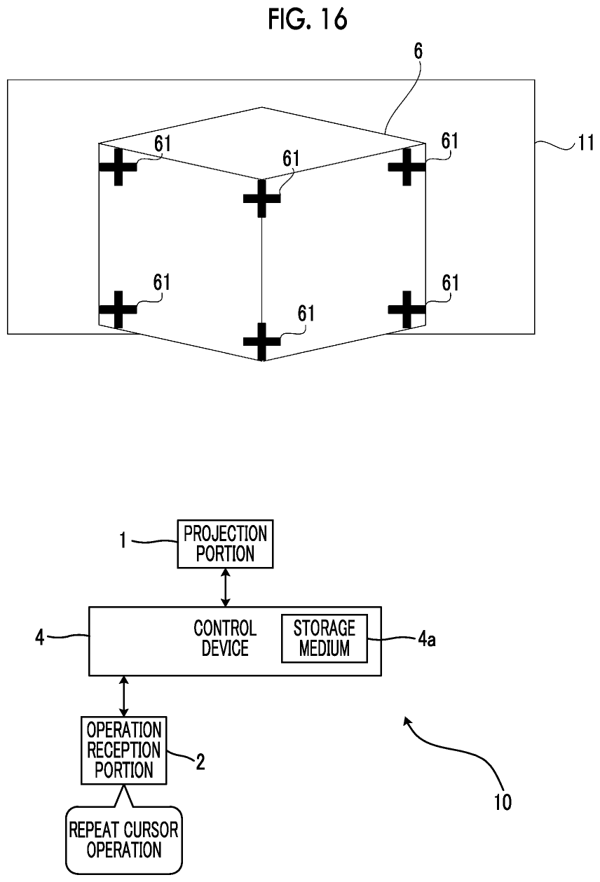

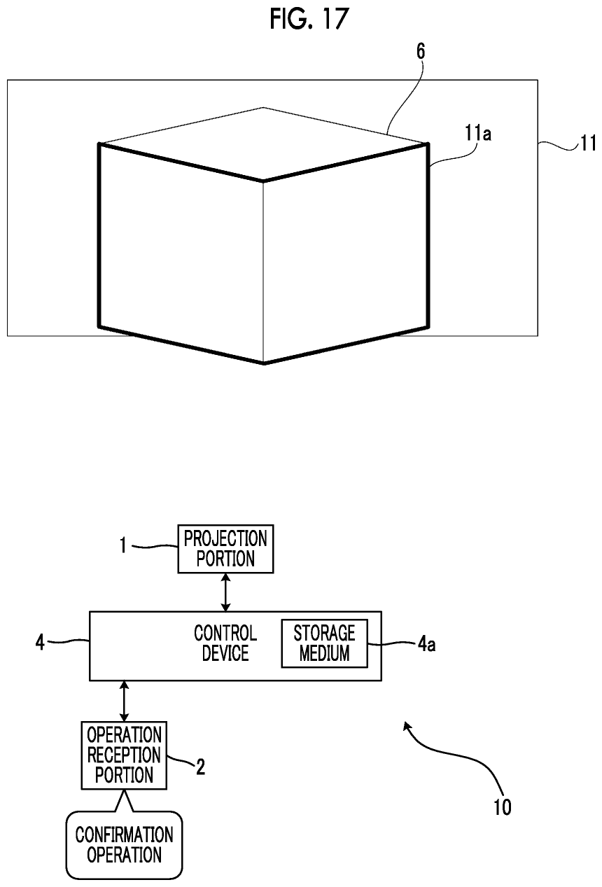

FIG. 16 and FIG. 17 are diagrams illustrating an example of the range setting for Modification Example 2 of the projection object 6 by the projection apparatus 10.

As illustrated in FIG. 16, for example, the projection object 6 may be a rectangular parallelepiped, two surfaces of the projection object 6 may face the projection apparatus 10 side, and these two surfaces may be set as the projection surface. For example, for the projection apparatus 10, the user sets the shape of the side surface (for example, two adjacent surfaces of a rectangular parallelepiped) in the projection apparatus 10.

Even in this case, the projection apparatus 10 first projects the cursor 61 based on the result of the reception of the designation of the number from the user by projecting the number image 51. The user arranges the cursor 61 to surround a desired projection surface in the projection object 6 by performing various cursor operations described above on the operation reception portion 2. In the example illustrated in FIG. 16, a range including two surfaces of the projection object 6 seen from the projection apparatus 10 side is surrounded using six cursors 61.

In this state, as illustrated in FIG. 17, in a case where the user performs the confirmation operation, the projection apparatus 10 sets the range surrounded by the cursors 61 as the content projection range 11a. The projection apparatus 10 generates the content image 111 in accordance with the content projection range 11a and projects the generated content image 111 to the content projection range 11a. In generating the content image 111, the projection apparatus 10 may perform distortion correction corresponding to an angle of each of the two surfaces included in the content projection range 11a in accordance with a user operation.

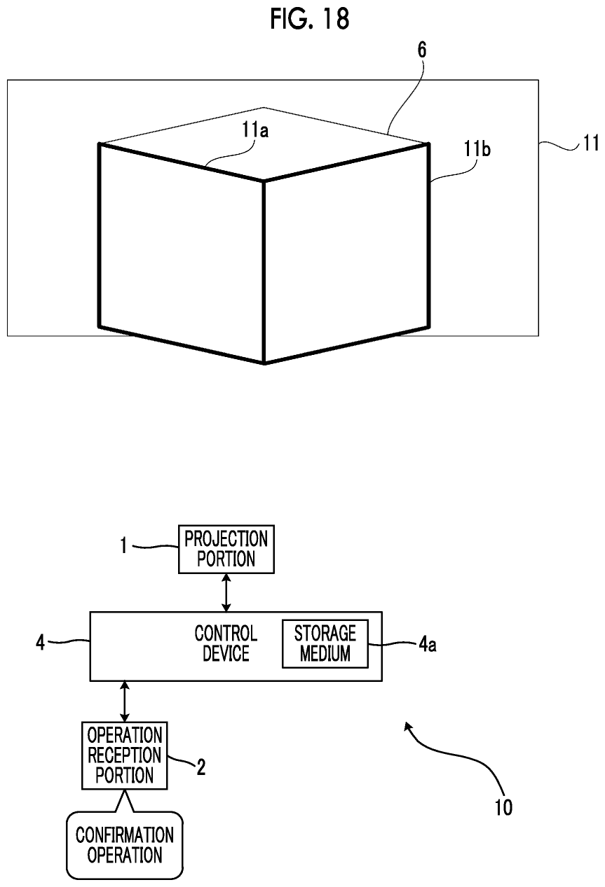

FIG. 18 is a diagram illustrating another example of the range setting for Modification Example 2 of the projection object 6 by the projection apparatus 10.

In the example illustrated in FIG. 16, in a case where the user performs the confirmation operation, the projection apparatus 10 may set content projection ranges 11a and 11b for projecting two content images 111 based on the position of each cursor 61. The content projection ranges 11a and 11b are two surfaces of the projection object 6 facing the projection apparatus 10 side.

The projection apparatus 10 generates the two content images 111 in accordance with the content projection ranges 11a and 11b and projects the generated content images 111 to the content projection ranges 11a and 11b, respectively. The two content images 111 may be images obtained by dividing one content image into two images or may be content images independent of each other.

In the projection apparatus 10, a plurality of the first ranges (for example, the content projection ranges 11a and 11b) may be designatable by the cursors 61, and different images may be projected to the plurality of first ranges as the content image. However, the two content images 111 projected to the content projection ranges 11a and 11b may be the same content image.

In generating the two content images 111, the projection apparatus 10 may perform distortion correction corresponding to an angle of each of the two surfaces of the content projection ranges 11a and 11b in accordance with a user operation.

Which one of the setting results in FIG. 17 and FIG. 18 is a setting result of the content projection range in a case where the user performs the confirmation operation in the example illustrated in FIG. 16 may be settable in accordance with a user operation. Alternatively, the setting result illustrated in FIG. 17 and the setting result illustrated in FIG. 18 may be switchable in accordance with a user operation.

<Range Setting for Projection Objects 6a and 6b by Projection Apparatus 10>

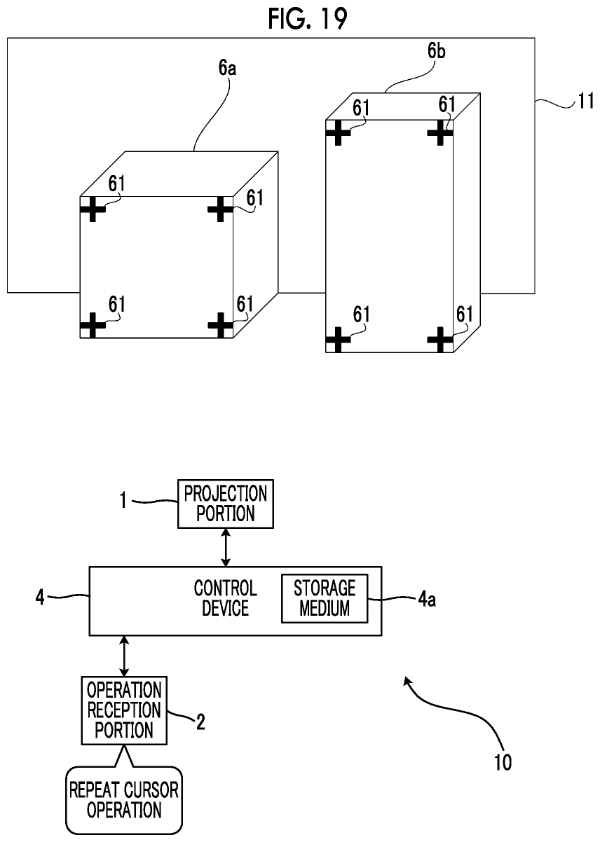

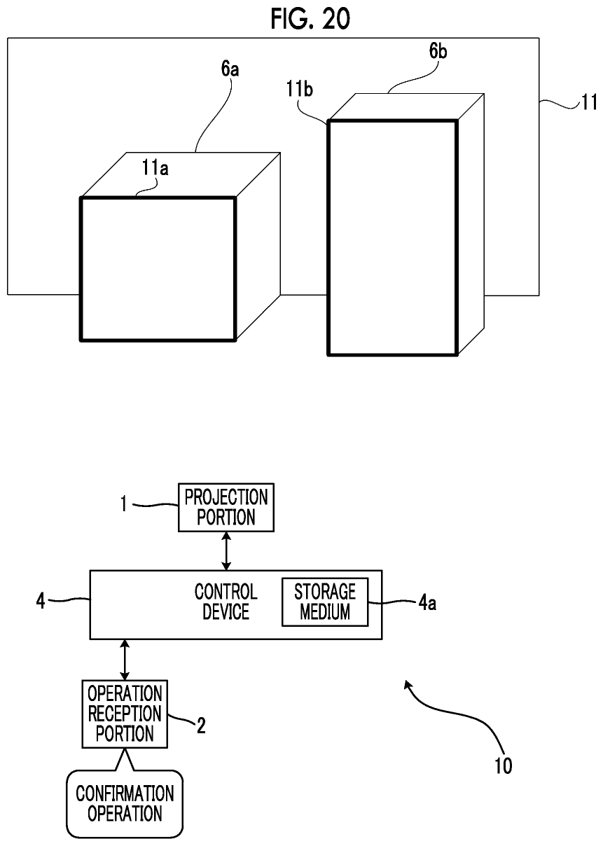

FIG. 19 and FIG. 20 are diagrams illustrating an example of the range setting for projection objects 6a and 6b by the projection apparatus 10.

While a case of projecting the content image 111 to one projection object 6 is described, the content image 111 may be projected to a plurality of projection objects. For example, as illustrated in FIG. 19 and FIG. 20, the projection apparatus 10 may perform projection to one surface of each of the projection objects 6a and 6b. The projection objects 6a and 6b are rectangular parallelepipeds having different shapes. For example, for the projection apparatus 10, the user sets the shape of the side surface (for example, one surface of each of two rectangular parallelepipeds) in the projection apparatus 10.

Even in this case, the projection apparatus 10 first projects the cursor 61 based on the result of the reception of the designation of the number from the user by projecting the number image 51. The user arranges the cursor 61 to surround a desired projection surface in the projection objects 6a and 6b by performing various cursor operations described above on the operation reception portion 2. In the example illustrated in FIG. 19, one surface of each of the projection objects 6a and 6b is surrounded using eight cursors 61.

In this state, as illustrated in FIG. 20, in a case where the user performs the confirmation operation, the projection apparatus 10 sets each range surrounded by the cursors 61 as the content projection ranges 11a and 11b. The projection apparatus 10 generates the two content images 111 in accordance with the content projection ranges 11a and 11b and projects the generated content images 111 to the content projection ranges 11a and 11b, respectively. In generating the content images 111, the projection apparatus 10 may perform distortion correction corresponding to the angle of each of the two surfaces of the content projection ranges 11a and 11b in accordance with a user operation.

<Modification Example of First Image for Providing Instruction for Content Projection Range by User>

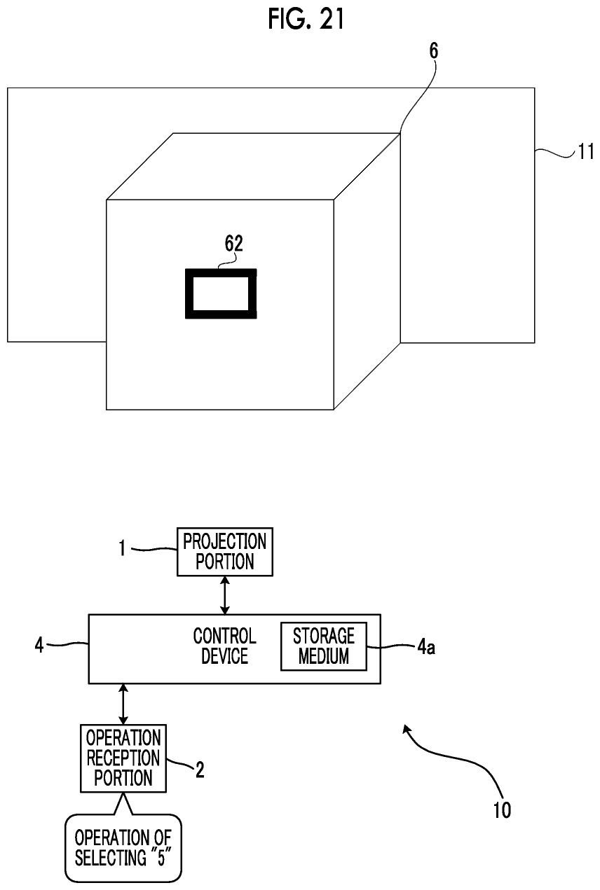

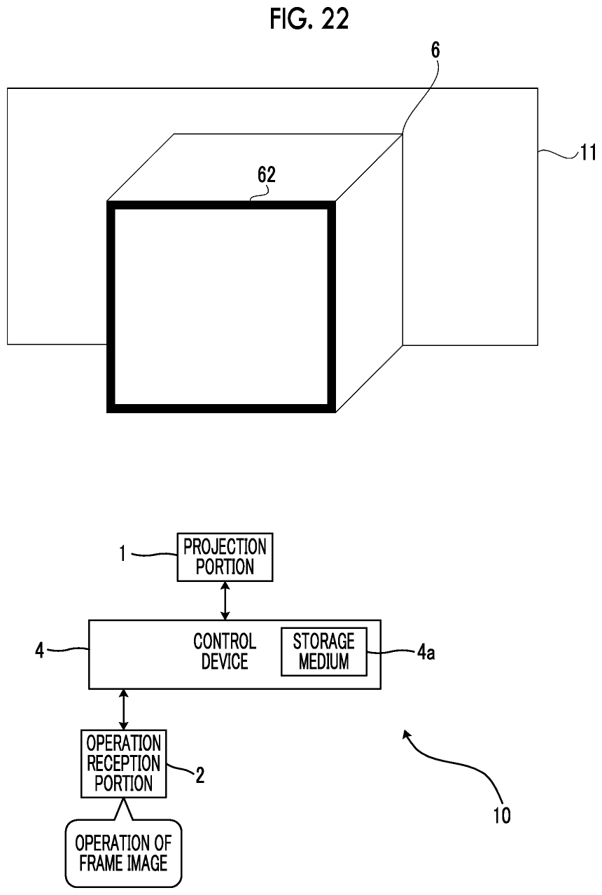

FIG. 21 and FIG. 22 are diagrams illustrating a modification example of the first image for providing an instruction for the content projection range by the user.

While the cursor 61 is illustratively described as the first image for providing an instruction for the content projection range by the user, the first image is not limited to the cursor 61. For example, the first image may be a frame image 62 illustrated in FIG. 21.

For example, in the state illustrated in FIG. 5, in a case where the user performs an operation of selecting “5” on the operation reception portion 2, the projection apparatus 10 projects the frame image 62 to a predetermined position (for example, a center) within the range of “5” in the number image 51. The frame image 62 is an image of which movement, enlargement, enlargement and reduction, modification, and the like can be performed by a user operation.

As illustrated in FIG. 21, the user matches the frame image 62 to four sides of the projection surface of the projection object 6 by operating the frame image 62 using the operation reception portion 2. In this state, in a case where the user performs the confirmation operation on the operation reception portion 2, the projection apparatus 10 sets a rectangular range surrounded by the frame image 62 as the content projection range 11a. Accordingly, as in the example in FIG. 10, the projection surface of the projection object 6 is set as the content projection range 11a.

A duplication operation for duplicating the frame image 62 may be performed in the operation reception portion 2 so that a plurality of content projection ranges (for example, the content projection ranges 11a and 11b) can be set.

As described above, the projection apparatus 10 projects the first image for providing an instruction for the first range for the projection of the content image by the user from the projection portion 1 to a position corresponding to a user operation (for example, an operation of selecting a number based on the number image 51) such that the first is superimposed on the projection image and sets the first range in accordance with a user operation performed on the first image. Accordingly, projection of the first image for providing the instruction for the first range for the projection of the content image by the user to a position different from the projection object and difficulty in finding the first image for the user can be avoided. Thus, the setting of the range in which the content image is projected can be facilitated.

Each of the above modification examples can be embodied in combination. For example, in the examples illustrated in FIG. 19 and FIG. 20, as illustrated in FIG. 13, light may not be projected to the edge part range 11c other than the content projection ranges 11a and 11b in the projection range 11 from the projection portion 1, or an image different from the content image 111 may be projected to the edge part range 11c.

In addition, while the number image 51 in which an identifier such as a number is attached to each range is illustratively described as the second image divided into a plurality of ranges, the second image is not limited thereto. For example, the second image may be an image divided into a plurality of ranges to which identifiers are not attached. In this case, for example, the projection apparatus 10 displays one range of the plurality of ranges of the second image in a highlighted manner and receives a user operation of providing an instruction to switch the highlighted range and a user operation of providing an instruction to select the range displayed in a highlighted manner as an initial projection range of the number image 51. Accordingly, the initial projection range of the number image 51 can be set without an identifier.

### Embodiment 2

Parts of Embodiment 2 different from Embodiment 1 will be described. In Embodiment 2, the first image for providing the instruction for the first range for the projection of the content image by the user is projected to a position except for an end part in the projection range 11 from the projection portion 1 such that the first image is superimposed on the projection image.

<Projection Processing of Content Image by Control Device 4 of Embodiment 2>

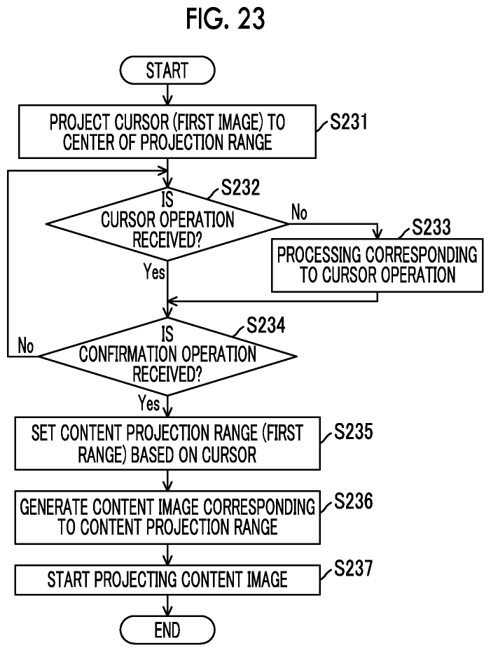

FIG. 23 is a flowchart illustrating an example of projection processing of the content image by the control device 4 of Embodiment 2. In Embodiment 2, for example, the control device 4 executes the projection processing illustrated in FIG. 23. For example, the control device 4 is triggered to start the projection processing illustrated in FIG. 23 by the setting start operation. Here, it is assumed that the projection range 11 of the projection apparatus 10 is adjusted to include the projection surface of the projection object 6 as in the examples in FIG. 5 to FIG. 10.

First, the control device 4 controls the projection portion 1 to project the cursor 61 to the center of the projection range 11 (step S231). In this case, the control device 4 may not perform the processing of projecting the number image 51. Steps S232 to S237 illustrated in FIG. 23 are the same as steps S1206 to S1211 illustrated in FIG. 12.

The projection apparatus 10 projects the cursor 61 (first image) for providing an instruction for the content projection range 11a for the projection of the content image 111 by the user to the center of the projection range 11. Accordingly, the cursor 61 is projected to a position except for the projection surface of the projection object 6 by approximately matching the center of the projection range 11 to a center of the projection surface of the projection object 6.

Thus, it is possible to avoid difficulty in finding the cursor 61 for the user and facilitate the setting of the content projection range 11a. In addition, since the user may not perform an operation (for example, the operation of selecting the number based on the number image 51) for setting a projection position of the cursor 61, the setting of the range in which the content image is projected can be further facilitated.

The projection position of the cursor 61 is not limited to the center of the projection range 11 and can be a predetermined position (as an example, a position slightly below the center of the projection range 11) other than the center of the projection range 11.

At least the following matters are disclosed in the present specification.

(1) A control method of a projection system that includes a projection portion and a processor and projects a content image to a first range set in a projection range of the projection portion, the control method comprising, by the processor, projecting a first image for providing an instruction for the first range by a user to a position corresponding to a user operation from the projection portion such that the first image is superimposed on a projection image, and executing a control of setting the first range in accordance with a user operation performed on the first image.

(2) The control method according to (1), in which the processor is configured to project a second image divided into a plurality of ranges from the projection portion, and execute a control of projecting the projection image including the first image to a position of a range selected by a user operation in the second image from the projection portion.

(3) The control method according to (2), in which the second image is a projection image in which each range of the plurality of ranges includes an identifier for selecting the range by the user.

(4) The control method according to (2) or (3), in which the second image is a projection image divided in accordance with a user operation.

(5) The control method according to any one of (2) to (4), in which the second image is a projection image divided in accordance with a size of the projection range.

(6) The control method according to any one of (2) to (5), in which the second image is a projection image divided in accordance with a shape of the projection range.

(7) The control method according to any one of (2) to (6), in which the processor is configured to execute a control of projecting the second image to a range selected by a user operation in the projection range from the projection portion.

(8) The control method according to any one of (1) to (7), in which the first image includes a cursor that moves in the projection image in accordance with a user operation.

(9) The control method according to (8), in which the cursor is a cursor duplicable in the projection image in accordance with a user operation.

(10) The control method according to any one of (1) to (9), in which an instruction for a plurality of the first ranges is providable using the first image, and the processor is configured to execute a control of projecting different images to the plurality of first ranges as the content image.

(11) The control method according to any one of (1) to (10), in which the processor is configured to execute a control of not projecting light or of projecting an image different from the content image to a range different from the first range in the projection range from the projection portion.

(12) A projection apparatus comprising a projection portion, and a processor, in which the projection apparatus projects a content image to a first range set in a projection range of the projection portion, and the processor is configured to project a first image for providing an instruction for the first range by a user to a position corresponding to a user operation from the projection portion such that the first image is superimposed on a projection image, and execute a control of setting the first range in accordance with a user operation performed on the first image.

(13) A control program of a projection apparatus that includes a projection portion and a processor and projects a content image to a first range set in a projection range of the projection portion, the control program causing the processor to execute a process comprising projecting a first image for providing an instruction for the first range by a user to a position corresponding to a user operation from the projection portion such that the first image is superimposed on a projection image, and setting the first range in accordance with a user operation performed on the first image.

(14) A control method of a projection system that includes a projection portion and a processor and projects a content image to a first range set in a projection range of the projection portion, the control method comprising, by the processor, projecting a first image for providing an instruction for the first range by a user to a position except for an end part from the projection portion such that the first image is superimposed on a projection image, and executing a control of setting the first range in accordance with a user operation performed on the first image.

(15) A projection apparatus comprising a projection portion, and a processor, in which the projection apparatus projects a content image to a first range set in a projection range of the projection portion, and the processor is configured to project a first image for providing an instruction for the first range by a user to a position except for an end part from the projection portion such that the first image is superimposed on a projection image, and execute a control of setting the first range in accordance with a user operation performed on the first image.

(16) A control program of a projection apparatus that includes a projection portion and a processor and projects a content image to a first range set in a projection range of the projection portion, the control program causing the processor to execute a process comprising projecting a first image for providing an instruction for the first range by a user to a position except for an end part from the projection portion such that the first image is superimposed on a projection image, and setting the first range in accordance with a user operation performed on the first image.

While various embodiments are described above with reference to the drawings, the present invention is not limited to such examples. It is apparent that those skilled in the art may perceive various modification examples or correction examples within the scope disclosed in the claims, and those examples are also understood as falling in the technical scope of the present invention. In addition, any combination of various constituents in the embodiment may be used without departing from the gist of the invention.

The present application is based on Japanese Patent Application (JP2020-077533) filed on Apr. 24, 2020, the content of which is incorporated in the present application by reference.

### EXPLANATION OF REFERENCES

1: projection portion
2: operation reception portion
2A, 3A: hollow portion
2a, 2b, 3a, 3c, 15a: opening
4: control device
4a: storage medium
6, 6a, 6b: projection object
10: projection apparatus
11: projection range
11a, 11b: content projection range
11c: edge part range
12: light modulation unit
15: housing
21: light source
22: light modulation portion
23: projection optical system
24: control circuit
31: second optical system
32, 122: reflective member
33: third optical system
34: lens
51: number image
61: cursor
62: frame image
101: body part
102: first member
103: second member
104: projection direction changing mechanism
105: shift mechanism
106: optical unit
111: content image
121: first optical system
G1: image

What is claimed is:

1. A control method of a projection system that includes a projection portion and a processor and projects a content image to a first range set in a projection range of the projection portion, the control method comprising:
executing, by the processor, a control of
projecting a second image, that is divided into a plurality of ranges, from the projection portion;
projecting, from the projection portion, an image including a first image for providing an instruction for the first range by a user to a position of a range selected by an operation of the user in the second image so that the image including the first image is superimposed on a projection image; and
setting the first range in accordance with an operation of the user performed on the first image.

2. The control method according to claim 1,
wherein the second image is an image in which each range of the plurality of ranges includes an identifier for selecting the range by the user.

3. The control method according to claim 1,
wherein the second image is an image divided in accordance with an operation of the user.

4. The control method according to claim 1,
wherein the second image is an image divided in accordance with a size of the projection range.

5. The control method according to claim 1,
wherein the second image is an image divided in accordance with a shape of the projection range.

6. The control method according to claim 1, which comprises:
executing, by the processor, a control of projecting, from the projection portion, the second image to a range selected by an operation of the user in the projection range.

7. The control method according to claim 1,
wherein the first image includes a cursor that moves in the projection image in accordance with an operation of the user.

8. The control method according to claim 7,
wherein the cursor is a cursor duplicable in the projection image in accordance with an operation of the user.

9. The control method according to claim 1,
wherein an instruction for a plurality of the first ranges is providable using the first image, and
the control method comprises executing, by the processor, a control of projecting different images respectively to the plurality of first ranges as the content image.

10. The control method according to claim 1, which comprises:
executing, by the processor, a control of not projecting light or of projecting an image different from the content image to a range different from the first range in the projection range from the projection portion.

11. A projection apparatus comprising:
a projection portion; and
a processor,
wherein the projection apparatus projects a content image to a first range set in a projection range of the projection portion, and
the processor is configured to execute a control of:
projecting a second image, that is divided into a plurality of ranges, from the projection portion;
projecting, from the projection portion, an image including a first image for providing an instruction for the first range by a user to a position of a range selected by an operation of the user in the second image so that the image including the first image is superimposed on a projection image; and
setting the first range in accordance with an operation of the user performed on the first image.

12. A non-transitory computer readable medium storing a control program of a projection apparatus that includes a projection portion and a processor and projects a content image to a first range set in a projection range of the projection portion, the control program causing the processor to execute a process comprising:
projecting a second image, that is divided into a plurality of ranges, from the projection portion;
projecting, from the projection portion, an image including a first image for providing an instruction for the first range by a user to a position of a range selected by an operation of the user in the second image so that the image including the first image is superimposed on a projection image; and
setting the first range in accordance with an operation of the user performed on the first image.
